(19) United States
(12) Patent Application Publication
(10) Pub. No.: US 2025/0335235 A1
(43) Pub. Date: Oct. 30, 2025

(54) SEMICONDUCTOR DEVICE, BOOT PROGRAM EXECUTION METHOD AND NON-TRANSITORY COMPUTER READABLE MEDIUM

(71) Applicant: Renesas Electronics Corporation, Tokyo (JP)

(72) Inventor: Kazuya MIZUGUCHI, Tokyo (JP)

(21) Appl. No.: 19/070,019

(22) Filed: Mar. 4, 2025

(30) Foreign Application Priority Data
Apr. 24, 2024 (JP) 2024-070693

(51) Int. Cl. G06F 9/48; G06F 13/28

(52) U.S. Cl. CPC G06F 9/4812; G06F 9/4856; G06F 13/28

(57) ABSTRACT

A semiconductor device 1 includes a CPU 11, a DMA controller 12, a first memory 13, and a second memory 14. The CPU 11 executes an initialization program in the first memory 13 to write an interrupt program and interrupt jump instructions into the second memory 14. The DMA controller 12 starts a DMA transfer process of a boot program to the second memory 14 by overwriting the interrupt jump instructions. The CPU 11 starts an execution process of the boot program after a predetermined time has elapsed since a start of the DMA transfer process. The CPU 11 executes the interrupt jump instruction when an instruction execution address reaches an address of a DMA untransferred area. The CPU 11 executes the interrupt program at a jump destination to delay the execution process of the boot program.

### CROSS-REFERENCE TO RELATED APPLICATIONS

The disclosure of Japanese Patent Application No. 2024-070693 filed on Apr. 24, 2024, including the specification, drawings and abstract is incorporated herein by reference in its entirety.

### BACKGROUND

This disclosure relates to a semiconductor device, a boot program execution method, and a non-transitory computer readable medium for storing a program.

In recent years, with the evolution of autonomous driving and connected technologies, the performance and functionality of in-vehicle systems have significantly advanced. Consequently, there is also a demand for reducing the startup time of in-vehicle systems. The startup process of in-vehicle systems is performed by the Central Processing Unit (CPU) installed in the system executing the boot program. The boot program is stored in the auxiliary storage and is transferred to the main storage device, such as a Random Access Memory (RAM), by the Direct Memory Access (DMA) controller during the startup of the in-vehicle system. Therefore, to reduce the startup time of in-vehicle systems, it is necessary to consider not only the time required for executing the boot program but also the time required for transferring the boot program from the auxiliary storage to the main storage.

There is a disclosed technique listed below. [Patent Document 1] Japanese Unexamined Patent Application Publication No. 2005-10942

For example, Patent Document 1 discloses a technology that reduces the startup time of a device by performing the transfer process and execution process of boot code (boot program) in parallel. The device disclosed in Patent Document 1 includes a CPU for executing boot code, a NAND flash as the transfer source of boot code, a RAM as the transfer destination of boot code, a bus control unit that outputs a request address for reading instructions included in the boot code transferred to the RAM, and a main storage/NAND flash control unit that generates an external wait signal to make the CPU wait.

The main storage/NAND flash control unit monitors the request address output from the bus control unit while performing the transfer process of the boot code from the NAND flash to the flash control unit generates an RAM. The main storage/NAND external wait signal if the request address is greater than the transfer address used for transferring the boot code from the NAND flash to the RAM, determining that the transfer of the boot code to be executed by the CPU is not complete. In this case, the transfer process of the boot code continues, but the execution process of the boot code by the CPU is interrupted. On the other hand, if the request address is smaller than the transfer address, the main storage/NAND flash control unit determines that the transfer of the boot code to be executed by the CPU is complete and does not generate an external wait signal. In this case, the transfer process of the boot code and the execution process of the boot code by the CPU are performed in parallel.

### SUMMARY

As described, the device disclosed in Patent Document 1 reduces the startup time by performing the transfer process of the boot code from the NAND flash to the RAM and the execution process of the boot code by the CPU in parallel. However, the device disclosed Patent in Document 1 requires the implementation of the main storage/NAND flash control unit (hardware) to monitor the relationship in magnitude between the request address and the transfer address to determine whether the transfer of the boot code to be executed by the CPU has been completed. The addition of such hardware leads to an increase in device cost.

Other problems and novel features will become apparent from the description of this specification and from the accompanying drawings.

A semiconductor device according to one embodiment includes a CPU, a first memory, a second memory, and a DMA controller. The CPU executes an initialization program stored in the first memory to write an interrupt program into the interrupt program writing area of the second memory and a plurality of interrupt jump instructions into the boot program writing area of the second memory. The DMA controller starts a DMA transfer process to transfer a boot program to the second memory by overwriting the plurality of interrupt jump instructions written in the second memory. The CPU starts an execution process of instructions included in the boot program DMA-transferred to the second memory after a predetermined time has elapsed since a start of the DMA transfer process. During the execution process of the instructions included in the boot program, the CPU executes the interrupt jump instruction when an instruction execution address of the CPU reaches an address of the boot program writing area of the second memory where the DAM transfer process has not been completed. After the instruction execution address of the CPU is changed to the address of the interrupt program writing area of the second memory by executing the interrupt jump instruction, the CPU executes the interrupt program to delay the execution process of the instructions included in the boot program.

According to this disclosure, it is possible to perform the transfer process and execution process of the boot program in parallel without adding hardware to monitor the relationship in magnitude between the request address and the transfer address. This allows for the reduction of the startup time of the semiconductor device while suppressing an increase in device cost.

### BRIEF DESCRIPTION OF THE DRAWINGS

FIG. 1 is a block diagram illustrating an example of a hardware configuration of a semiconductor device according to a first embodiment.

FIG. 2 is a flowchart illustrating an example of a process flow of a boot program execution method.

FIG. 3 is a diagram illustrating an example of a memory map of a second memory according to the first embodiment.

FIG. 4 is a diagram illustrating an example of the memory map of the second memory according to the first embodiment.

FIG. 5 is a diagram illustrating an example of the memory map of the second memory according to the first embodiment.

FIG. 6 is a diagram illustrating an example of the memory map of the second memory according to the first embodiment.

FIG. 7 is a diagram illustrating an example of the memory map of the second memory according to the first embodiment.

FIG. 8 is a block diagram illustrating an example of a hardware configuration of a semiconductor device according to a second embodiment.

FIG. 9 is a diagram illustrating an example of a memory map of a second memory according to the second embodiment.

### DETAILED DESCRIPTION

Embodiments will be described below in detail with reference to the drawings. Like components are denoted with like reference numerals and will not be repeatedly described in the present specification and the drawings. In the drawings, for convenience of description, the configuration may be omitted or simplified.

The program may be stored in various types of non-transitory computer readable media or tangible storage media. By way of example and not limitation, non-transitory computer readable media or tangible storage media include RAM, Read Only Memory (ROM), flash memory, Solid State Drive (SSD) or other memory technologies, Compact Disc (CD)-ROM, Digital Versatile Disc (DVD), Blu-ray (registered trademark) disc or other optical disc storages, magnetic cassette, magnetic tape, magnetic disk storage or other magnetic storage devices. The program may also be transmitted on various types of transitory computer readable media or communication media. By way of example and not limitation, transitory computer readable media or communication media include electrical, optical, acoustic, or other forms of propagated signals.

### First Embodiment

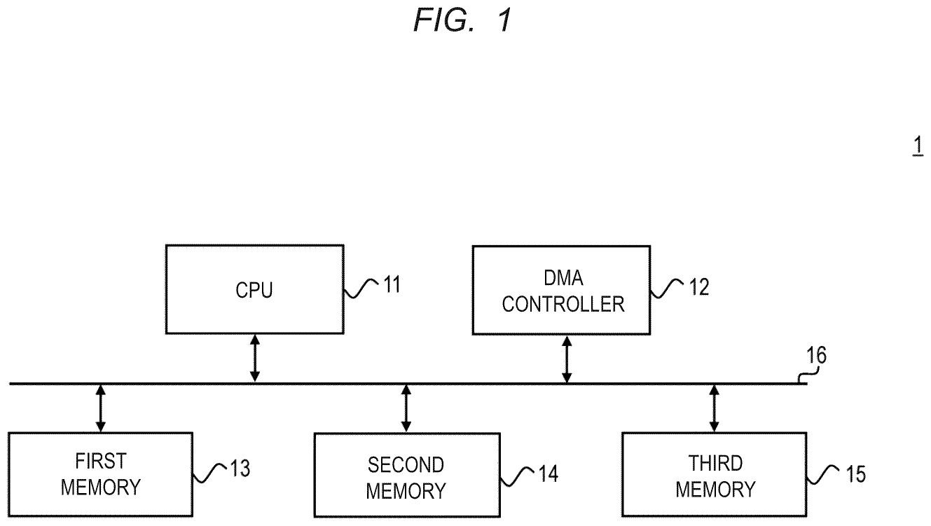

FIG. 1 is a block diagram illustrating an example of a hardware configuration of a semiconductor device 1 according to a first embodiment. As shown in FIG. 1, the semiconductor device 1 includes a CPU 11, a DMA controller 12, a first memory 13, a second memory 14, a third memory 15, and a bus 16. The CPU 11 and the DMA controller 12 are configured to be able to access the first memory 13, the second memory 14, and the third memory 15 via the bus 16. Additionally, the CPU 11 and the DMA controller 12 are configured to be able to access each other via the bus 16.

The CPU 11 executes a control program stored in the first memory 13 and a boot program stored in the second memory 14. The control program is a program for causing the semiconductor device 1 to execute a boot program execution method.

The DMA controller 12 executes DMA transfers of data stored in the first to third memories 13-15 based on DMA transfer parameters. The DMA transfer parameters are information necessary for performing DMA transfers, such as transfer source addresses and transfer destination addresses, and are set by the CPU 11 before performing the DMA transfer.

The first memory 13 is configured, for example, by a non-volatile memory such as a ROM, and stores the control program executed by the CPU 11. The control program includes an initialization program for performing an initialization process of the second memory 14, a DMA transfer process program for causing the DMA controller 12 to execute a DMA transfer, and a boot program execution process program for executing the boot program.

The second memory 14 is configured by a volatile memory such as a RAM, and has an interrupt program writing area and a boot program writing area. An interrupt program including an instruction to delay an execution process of the boot program is written in the interrupt program writing area. Additionally, the boot program is written into the boot program writing area by a DMA transfer.

The third memory 15 is configured by a non-volatile memory such as a flash ROM, and stores the boot program. The boot program is a program that defines the operation at the startup of the semiconductor device 1. The boot program stored in the third memory 15 is DMA-transferred to the second memory 14 by the DMA controller 12 at the startup of the semiconductor device 1. In the configuration example shown in FIG. 1, the third memory 15 is included in the semiconductor device 1, but it may also be a memory device located outside the semiconductor device 1.

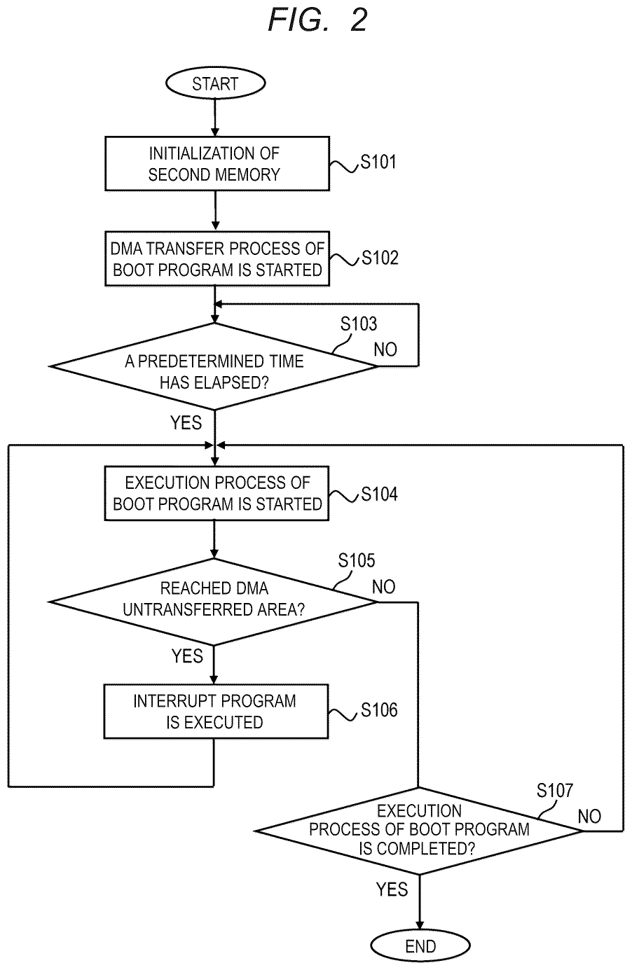

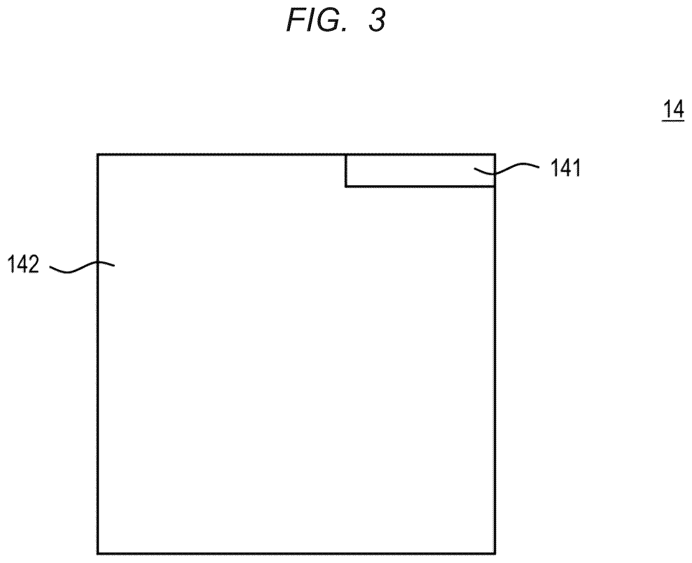

Next, the boot program execution method performed in the semiconductor device 1 according to the first embodiment will be described with reference to FIGS. 2-7. FIG. 2 is a flowchart illustrating an example of a process flow of the boot program execution method. The flowchart of FIG. 2 includes seven process steps consisting of steps S101-S107. Additionally, FIGS. 3-7 are diagrams for explaining the boot program transfer process and boot program execution process in the second memory 14.

In the step S101 of FIG. 2, the initialization process of the second memory is executed. When power supply to the semiconductor device 1 is started and the reset signal is deactivated, the CPU 11 reads and executes the initialization program stored in the first memory 13. The CPU 11 executes the initialization program to write the interrupt program including the instruction to delay the execution process of the boot program into the interrupt program writing area of the second memory 14 and to write a plurality of interrupt jump instructions including instructions to change an instruction execution address of the CPU 11 to an address of the interrupt program writing area into the boot program writing area of the second memory 14.

FIG. 3 is a diagram illustrating an example of a memory map of the second memory 14 before the initialization process of the step S101 is performed. As shown in FIG. 3, the second memory 14 has an interrupt program writing area 141 and a boot program writing area 142. The sizes of the interrupt program writing area 141 and the boot program writing area 142 are preferably determined according to the sizes of the interrupt program and the boot program. Additionally, the position of the interrupt program writing area 141 in FIG. 3 is an example and is not limited to the position shown in FIG. 3.

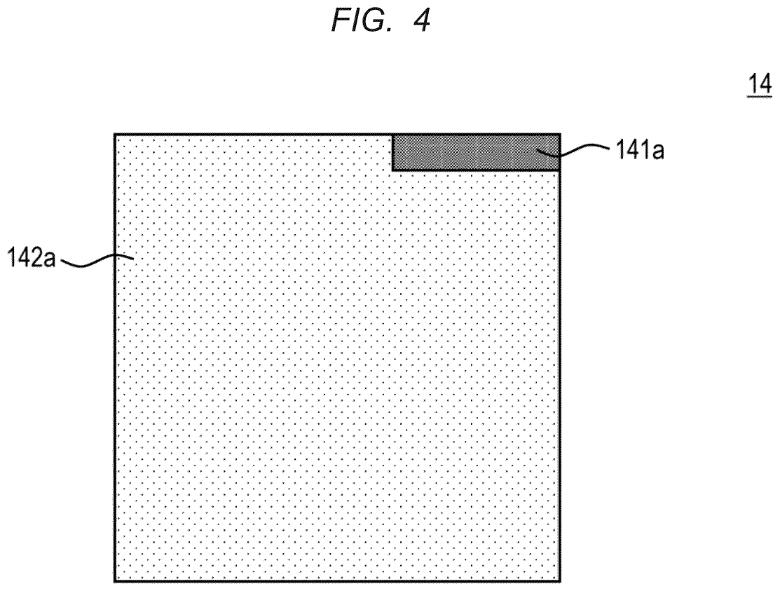

FIG. 4 is a diagram illustrating an example of the memory map of the second memory 14 after the initialization process of the step S101 is performed. As shown in FIG. 4, the interrupt program is written into the interrupt program writing area 141. Additionally, the plurality of interrupt jump instructions are written into the boot program writing area 142. That is, the entire area where the boot program will be written in a future process step is filled with interrupt jump instructions. In FIG. 4, the state where the interrupt program is written into the area 141 is represented by the interrupt program writing reference numeral 141a, and the state where the interrupt jump instructions are written into the boot program writing area 142 is represented by the reference numeral 142a. The same applies to other drawings.

The writing processes of the interrupt program and the interrupt jump instructions in the initialization process of the step S101 can also be performed using the DMA controller 12. That is, the CPU 11 executes the initialization program to cause the DMA controller 12 to perform DMA transfer processes of the interrupt program and the plurality of interrupt jump instructions to the interrupt program writing area 141 and the boot program writing area 142 of the second memory 14. In this case, the initialization program includes a program for setting DMA transfer parameters necessary for the DMA controller 12 to perform the DMA transfer processes of the interrupt program and the plurality of interrupt jump instructions. The interrupt program and the plurality of interrupt jump instructions to be DMA-transferred may be stored in either the first memory 13 or the third memory 15.

In the step S102 of FIG. 2, the DMA transfer process of the boot program is started. The CPU 11 reads and executes the DMA transfer process program stored in the first memory 13. By executing the DMA transfer process program, a setting process of DMA transfer parameters necessary for the DMA controller 12 to perform the DMA transfer of the boot program from the third memory 15 to the second memory 14 is performed, and after the completion of the setting process, a start instruction for the DMA transfer is output. As a result, the DMA controller 12 starts the DMA transfer process to transfer the boot program stored in the third memory 15 to the second memory 14 by overwriting the plurality of interrupt jump instructions written in the boot program writing area 142.

In the step S103 of FIG. 2, it is determined whether a predetermined time has elapsed since the start of the DMA transfer process of the boot program. The CPU 11 reads and executes the boot program execution process program stored in the first memory 13. As a result, the CPU 11 controls the timing for starting the execution process of the boot program DMA-transferred to the second memory 14. In this disclosure, the execution process of the boot program is started before the completion of the entire DMA transfer process of the boot program. That is, in this disclosure, by adopting a method of performing the boot program transfer process and the boot program execution process in parallel, the startup time of the semiconductor device 1 is shortened. The predetermined time in the step S103, that is, the time from the start of the DMA transfer process of the boot program to the start of the execution process of the boot program, can be determined according to, for example, the DMA transfer process speed of the boot program and the execution process speed of the boot program.

If it is determined that a predetermined time has elapsed since the start of the DMA transfer process of the boot program (YES in the step S103), the process proceeds to the step S104. On the other hand, if it is not determined that a predetermined time has elapsed since the start of the DMA transfer process of the boot program (NO in the step S103), the process returns to the step S103.

In the step S104 of FIG. 2, the execution process of the boot program is started. The CPU 11 starts the execution process of the instructions included in the boot program DMA-transferred to the second memory 14 after a predetermined time has elapsed since the start of the DMA transfer process of the boot program.

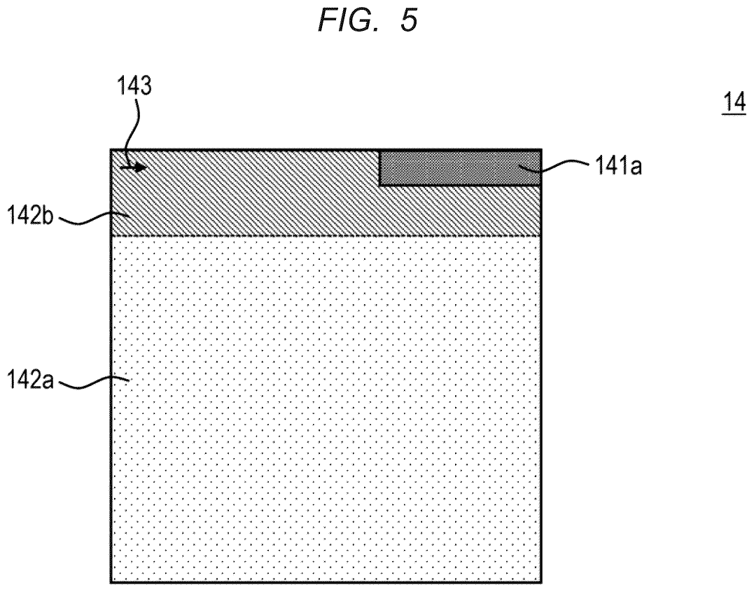

FIG. 5 is a diagram illustrating an example of the memory map of the second memory 14 in which the execution process of the boot program has started. In FIG. 5, the state where the boot program is written by overwriting the interrupt jump instructions is represented by the reference numeral 142b, and the status of the execution process of the boot program is represented by an arrow with the reference numeral 143. The same applies to other drawings.

The CPU 11 performs an execution process of instructions included in a program using an address indicated by a program counter as an instruction execution address. That is, when the CPU 11 executes the boot program written in the second memory 14, the address corresponding to the boot program writing area 142 of the second memory 14 is designated as the instruction execution address of the CPU 11. The address of the location at the tip of the arrow in FIG. 5 corresponds to the instruction execution address of the CPU 11 at the time shown in FIG. 5. The CPU 11 fetches and executes the instructions of the boot program writing area 142 corresponding to the instruction execution address.

Moreover, due to the time difference between the start of the DMA transfer process of the boot program and the start of the execution process of the boot program, as shown in FIG. 5, at the point when the execution process of the boot program starts, the range of the boot program writing area 142b where the DMA transfer of the boot program is completed becomes larger. This allows for avoiding the situation where the instruction execution address of the CPU 11 quickly surpasses the address of the area where the DMA transfer is completed when the execution process speed of the boot program is greater than the DMA transfer process speed of the boot program.

In the step S105 of FIG. 2, it is determined whether the instruction execution address of the CPU 11 has reached the address of the DMA untransferred area of the boot program. As the CPU 11 increments the instruction execution address and sequentially executes the instructions included in the DMA-transferred boot program, it is conceivable that the instruction execution address of the CPU 11 may reach the address of the area where the DMA transfer of the boot program has not completed (DMA untransferred area). Since the DMA untransferred area is an area before the overwrite process by the boot program is performed, the interrupt jump instruction is written. That is, during the execution process of the instructions included in the boot program, when the instruction execution address of the CPU 11 reaches the address of the boot program writing area where the DMA transfer process has not completed, the CPU 11 executes the interrupt jump instruction. By executing the interrupt jump instruction, the CPU 11 recognizes that its instruction execution address of the CPU 11 has reached the address of the DMA untransferred area of the boot program.

There are mainly two cases considered where the instruction execution address of the CPU 11 reaches the address of the DMA untransferred area of the boot program. The first case is when the execution process speed of the boot program is greater than the DMA transfer process speed of the boot program, causing the instruction execution address of the CPU 11 to catch up with the address of the boot program writing area 142 of the second memory 14 where the DMA transfer process of the boot program is being performed. The second case is when the boot program includes a branch instruction, and the branch destination of the branch instruction is located within the DMA untransferred area of the boot program. When the CPU 11 executes such a branch instruction, the instruction execution address of the CPU 11 reaches the address of the DMA untransferred area of the boot program.

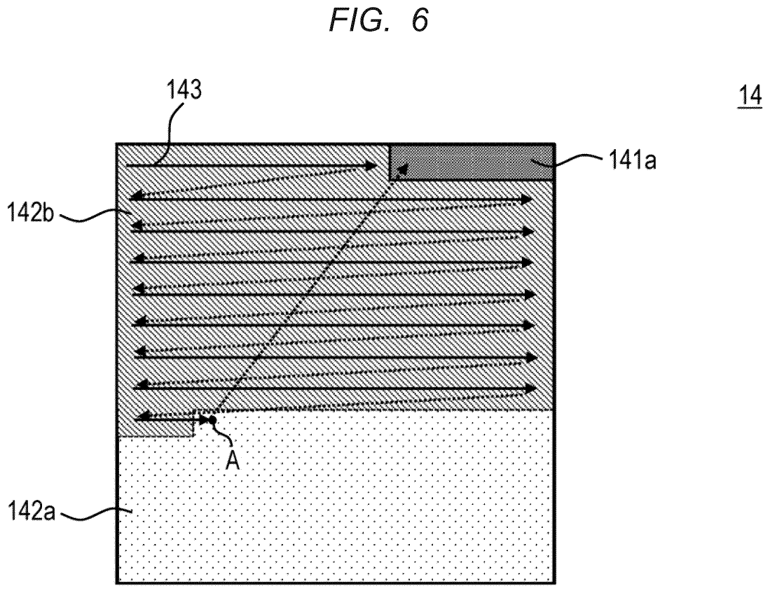

FIG. 6 is a diagram illustrating an example of the memory map of the second memory 14 when the instruction execution address of the CPU 11 reaches the DMA untransferred area of the boot program. The example in FIG. 6 corresponds to the first case mentioned above. As shown in FIG. 6, the instruction execution address of the CPU 11 has reached the address of the point A, which is included in the DMA untransferred area of the boot program. Since the DMA untransferred area of the boot program is in a state before the interrupt jump instruction is overwritten, it corresponds to the boot program writing area 142a where the interrupt jump instruction is written. The CPU 11 executes the interrupt jump instruction written at the position of the point A and changes the instruction execution address of the CPU 11 to the address of the interrupt program writing area 141a where the interrupt program is written.

If it is determined that the instruction execution address of the CPU 11 has reached the address of the DMA untransferred area of the boot program, in other words, if the CPU 11 has executed the interrupt jump instruction (YES in the step S105), the process proceeds to the step S106. On the other hand, if it is not determined that the instruction execution address of the CPU 11 has reached the address of the DMA untransferred area of the boot program, in other words, if the CPU 11 has not executed the interrupt jump instruction (NO in the step S105), the process proceeds to the step S107.

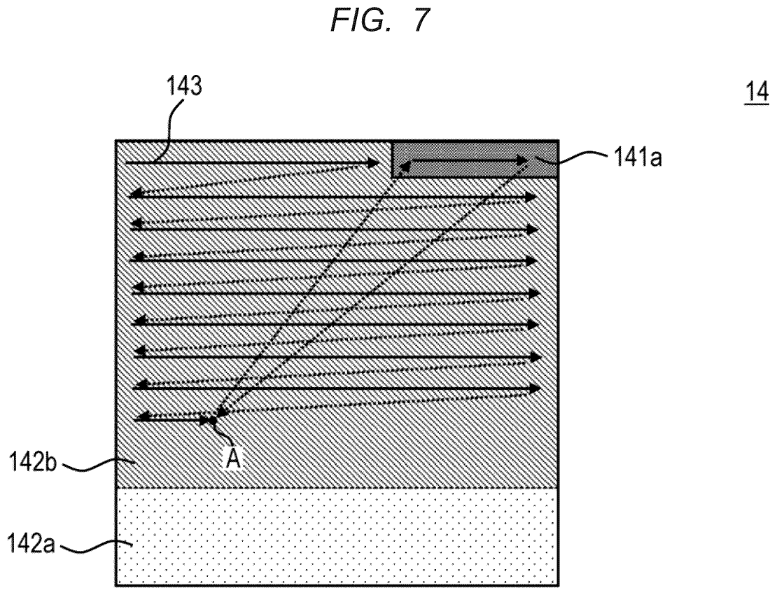

In the step S106 of FIG. 2, the interrupt program including the instruction to delay the execution process of the boot program is executed. After the execution of the interrupt jump instruction changes the instruction execution address of the CPU 11 to the address of the interrupt program writing area 141a where the interrupt program is written, the CPU 11 executes the interrupt program written in the interrupt program writing area 141a to delay the execution process of the instructions included in the boot program. FIG. 7 is a diagram illustrating an example of the memory map of the second memory 14 when the interrupt program is executed. As shown in FIG. 7, the CPU 11 executes the interrupt program written in the interrupt program writing area 141a. Since the interrupt program includes the instruction to delay the execution process of the boot program, the CPU 11 executes the interrupt program to wait for the execution process of the boot program.

The time to delay the execution process of the instructions included in the boot program, that is, the waiting time for the execution process of the boot program, may be determined according to the difference between the DMA transfer process speed of the boot program and the instruction execution process speed of the boot program. For example, if the DMA transfer process speed of the boot program is smaller than the instruction execution process speed of the boot program, and the difference between their speeds is large, the waiting time for the execution process of the boot program may be set longer. Also, even if the DMA transfer process speed of the boot program is smaller than the instruction execution process speed of the boot program, if the difference between their speeds is relatively small, the waiting time for the execution process of the boot program may be set shorter.

After executing the interrupt program to perform the process to delay the execution process of the instructions included in the boot program, the CPU 11 sets the address where the executed interrupt jump instruction has been written as the instruction execution address again to resume the execution process of the instructions included in the boot program. That is, the process after performing the step S106 returns to the step S104.

As shown in FIG. 7, after executing the interrupt program, the instruction execution address of the CPU 11 returns to the point A again. While the execution process of the boot program is on hold, the DMA transfer process of the boot program by the DMA controller 12 progresses. That is, the range of the boot program writing area 142b in FIG. 7 is wider than the range of the boot program writing area 142b in FIG. 6. As a result, the point A in FIG. 7 is included in the boot program writing area 142b where the DMA transfer process of the boot program has been completed. As a result, the CPU 11 can resume the execution process of the instructions included in the boot program.

In the step S107 of FIG. 2, it is determined whether the execution process of the boot program has been completed. If it is determined that the execution process of the boot program has been completed (YES in the step S107), the example of the process flow shown in FIG. 2 ends. On the other hand, if it is not determined that the execution process of the boot program has been completed (NO in the step S107), the process returns to the step S104, and the execution process of the boot program continues.

As described above, according to the first embodiment, before performing the DMA transfer process of the boot program from the third memory 15 to the second memory 14, an interrupt jump instructions are written in the area of the second memory 14 where the boot program is written by the DMA transfer. The execution process of the boot program by the CPU 11 is started after a predetermined time has elapsed from the start of the DMA transfer process of the boot program by the DMA controller 12. During the execution process of the boot program, when the instruction execution address of the CPU 11 reaches the address of the DMA untransferred area of the boot program, the CPU 11 executes the interrupt jump instruction, and the instruction execution address of the CPU 11 is changed to the address of the area where the interrupt program including the instruction to delay the execution process of the boot program is written. The CPU 11 executes the interrupt program to delay the execution process of the boot program and then resumes the execution process of the boot program.

Thus, the semiconductor device 1 according to the first embodiment can reduce the startup time of the semiconductor device 1 by performing the DMA transfer process of the boot program and the execution process of the boot program in parallel. Also, by writing the interrupt jump instructions and the interrupt program in the second memory 14, which is the transfer destination of the boot program, before the DMA transfer of the boot program is started, the process of detecting that the instruction execution address of the CPU 11 has reached the address of the DMA untransferred area of the boot program and the process of waiting for the execution process of the boot program are realized. This eliminates the need for hardware to monitor the progress of the execution process and the DMA transfer process of the boot program, thereby suppressing an increase in device cost.

### Second Embodiment

A second embodiment will be described. In the first embodiment 1, a semiconductor device equipped with a single DMA controller was described. In the second embodiment, a semiconductor device equipped with a plurality of DMA controllers is described.

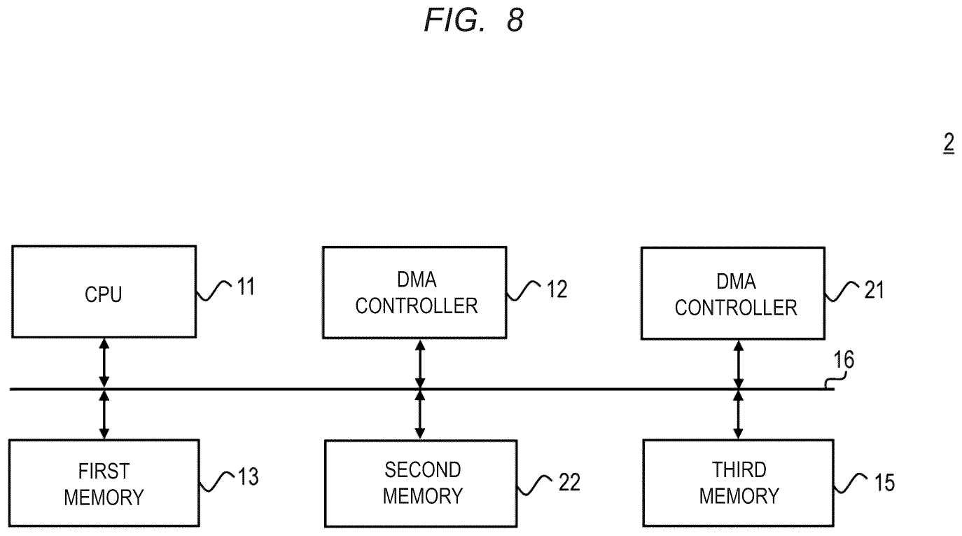

FIG. 8 is a block diagram illustrating an example of a hardware configuration of a semiconductor device 2 according to the second embodiment. As shown in FIG. 8, the semiconductor device 2 according to the second embodiment includes a DMA controller 21 in addition to the configuration of the semiconductor device 1 according to the first embodiment. Additionally, the second memory 14 is changed to a second memory 22.

The DMA controller 21 is connected to the bus 16 and has DMA transfer capabilities similar to the DMA controller 12. In the semiconductor device 2 according to the second embodiment, a DMA transfer is performed using the DMA controller 12 (first DMA controller) and the DMA controller 21 (second DMA controller).

The second memory 22 is the same as the second memory 14 in that it has an interrupt program writing area and a boot program writing area. However, the second memory 22 differs from the second memory 14 in that it includes both a first boot program writing area and a second boot program writing area within the boot program writing area. Among the DMA transfer processes related to the boot program writing area, the DMA transfer process related to the first boot program writing area is performed by the DMA controller 12, and the DMA transfer process related to the second boot program writing area is performed by the DMA controller 21.

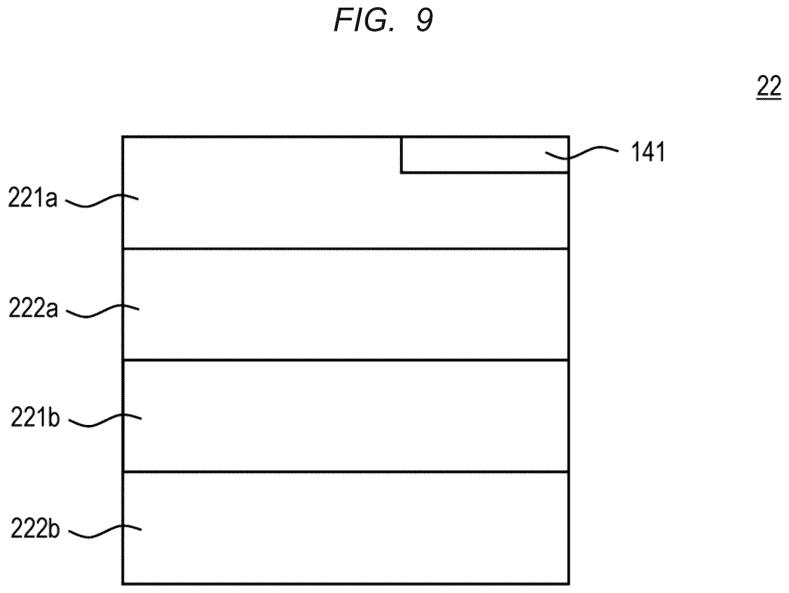

FIG. 9 is a diagram illustrating an example of a memory map of the second memory 22 before the initialization process is executed. As shown in FIG. 9, the second memory 22 includes a boot program writing area configured by a first boot program writing areas 221a and 221b and a second boot program writing areas 222a and 222b. The first boot program writing areas 221a and 221b are arranged apart from each other. The same applies to the second boot program writing areas 22a and 222b. In this disclosure, the first boot program writing areas 221a and 221b are collectively referred to as a first boot program writing area 221. Additionally, the second boot program writing areas 222a and 222b are collectively referred to as a second boot program writing area 222.

Next, referring to FIG. 2, a boot program execution method performed in the semiconductor device 2 according to the second embodiment will be described. Since the difference between the first and second embodiments is in the process related to the DMA transfer, the process flow of the boot program execution method in the second embodiment will be explained with a focus on the parts related to the DMA transfer process, and the explanation of other parts will be omitted.

The DMA controllers 12 and 21 may be used for the write process of the interrupt program and the interrupt jump instruction in the initialization process in the step S101 of FIG. 2. Namely, the CPU 11 executes the initialization program to cause the DMA controllers 12 and 21 to perform the DMA transfer processes of the interrupt program and the plurality of interrupt jump instructions to the second memory 22. In this case, the initialization program includes a program for setting DMA transfer parameters necessary for the DMA controllers 12 and 21 to perform the DMA transfer processes of the interrupt program and the plurality of interrupt jump instructions. By using two DMA controllers, it is possible to perform the write processes of the interrupt program and the interrupt jump instructions in a shorter time than in the first embodiment which uses a single DMA controller.

When performing the writing processes of the interrupt program and interrupt jump instructions using the DMA controllers 12 and 21, the DMA controller 12 may write the plurality of interrupt jump instructions into the first boot program writing area 221a, and the DMA controller 21 may write the plurality of interrupt jump instructions into the second boot program writing area 222a. Additionally, either of the DMA controllers 12 and 21 may write the interrupt program into the interrupt program writing area 141.

In the step S102 of FIG. 2, the DMA controllers 12 and 21 are used for the DMA transfer process of the boot program. That is, the CPU 11 executes the DMA transfer process program to perform setting process of DMA transfer parameters necessary for the DMA controllers 12 and 21 to perform the DMA transfer of the boot program from the third memory 15 to the second memory 22, and after the completion of the setting process, a start instruction for the DMA transfer is output.

When the DMA controllers 12 and 21 are used for the DMA transfer process of the boot program, the DMA controller 12 performs the DMA transfer process of a part of the boot program, and the DMA controller 21 performs the DMA transfer process of the remaining part of the boot program. In this disclosure, the part of the boot program transferred by the DMA controller 12 is referred to as a first part of the boot program, and the part of the boot program transferred by the DMA controller 21 is referred to as a second part of the boot program. In other words, the boot program includes the first part and the second part.

Therefore, in the step S102 of FIG. 2, the DMA controller 12 starts the DMA transfer process (first DMA transfer process) to transfer the first part of the boot program stored in the third memory 15 to the second memory 22 by overwriting the plurality of interrupt jump instructions written in the first boot program writing area 221. Additionally, the DMA controller 21 starts the DMA transfer process (second DMA transfer process) to transfer the second part of the boot program stored in the third memory 15 to the second memory 22 by overwriting the plurality of interrupt jump instructions written in the second boot program writing area 222.

It is desirable that the DMA controllers 12 and 21 prioritize performing the DMA transfer process related to the area near the beginning of the boot program within the boot program writing area. For example, in the memory map of the second memory 22 in FIG. 9, when the boot program is executed from the upper left of the second memory 22 in the step S104 of FIG. 2, it is desirable that the DMA controller 12 starts performing from the DMA transfer process related to the first boot program writing area 221a, and the DMA controller 21 starts performing from the DMA transfer process related to the second boot program writing area 222a.

In the step S104 of FIG. 2, after a predetermined time has elapsed since the start of the DMA transfer process by the DMA controller 12 and the DMA transfer process by the DMA controller 21, the CPU 11 starts the execution process of the instructions included in the boot program DMA-transferred to the second memory 22. In the second embodiment, since the DMA transfer process is performed using two DMA controllers, the DMA transfer process speed in the second embodiment is greater than that in the first embodiment. Therefore, the time from the start of the DMA transfer process of the boot program to the start of the execution process of the boot program in the second embodiment may be shorter than that in the first embodiment.

In the step S105 of FIG. 2, during the execution process of the instructions included in the boot program, the CPU 11 executes the interrupt jump instruction when the instruction execution address of the CPU 11 reaches the address of the boot program writing area where the DMA transfer process by the DMA controller 12 or the DMA transfer process by the DMA controller 21 has not been completed. By executing the interrupt jump instruction, the CPU 11 recognizes that the instruction execution address of the CPU 11 has reached the address of the area where the DMA transfer of the boot program by the DMA controllers 12 and 21 has not completed, that is, the address of the DMA untransferred area.

Similarly to the first embodiment, in the second embodiment as well, the execution process of the instructions included in the boot program is delayed by executing the interrupt program in the step S106. Since the DMA transfer process speed in the second embodiment is greater than that in the first embodiment, the time to delay the execution process of the instructions included in the boot program in the second embodiment, that is, the waiting time for the execution of the boot program may be shorter than that in the first embodiment. As described above, the second embodiment, like the first embodiment, can reduce the startup time of the semiconductor device by performing the DMA transfer process of the boot program and the execution process of the boot program in parallel.

Furthermore, in the second embodiment, the DMA transfer process of the boot program is performed by using two DMA controllers, it is possible to significantly increase the DMA transfer process speed of the boot program compared to the first embodiment. Therefore, if the DMA transfer process speed of the boot program is less than the execution process speed of the boot program, the difference between their speeds can be reduced by using two DMA controllers. This makes it less likely for the instruction execution address of the CPU 11 to catch up with the address of the boot program writing area while the DMA transfer process of the boot program is being performed. This reduces the number of executions of the interrupt program to delay the execution process of the boot program, thereby achieving further reduction in the startup time of the semiconductor device.

In the second embodiment, an example was described in which two DMA controllers are used to perform the DMA transfer process of the boot program, but the number of DMA controllers may be multiple and is not limited to two. For example, if the semiconductor device is equipped with three DMA controllers, three DMA controllers may be used for the DMA transfer process of the boot program. In this case, the boot program writing area of the second memory should be configured to include a first to third boot program writing areas. Also, using the DMA controllers already installed in the semiconductor device does not lead to an increase in device cost.

In the second embodiment, an example was described in which each of the first boot program writing area 221 and the second boot program writing area 222 includes two areas arranged apart from each other, but the number of areas arranged apart from each other may be multiple and is not limited to two.

Although the invention made by the inventor has been specifically described based on the embodiment, the present invention is not limited to the embodiment already described, and it is needless to say that various modifications can be made without departing from the gist thereof.

What is claimed is:

1. A semiconductor device comprising:
a CPU;
a first memory configured to store an initialization program;
a second memory having an interrupt program writing area and a boot program writing area; and
a DMA controller,
wherein the CPU is configured to execute the initialization program to write an interrupt program including an instruction to delay an execution process of a boot program into the interrupt program writing area and to write a plurality of interrupt jump instructions including instructions to change an instruction execution address of the CPU to an address of the interrupt program writing area into the boot program writing area,
wherein the DMA controller is configured to start a DMA transfer process to transfer the boot program stored in a third memory to the second memory by overwriting the plurality of interrupt jump instructions written in the boot program writing area, and
wherein the CPU is configured to:
after a predetermined time has elapsed since a start of the DMA transfer process, start an execution process of instructions included in the boot program DMA-transferred to the second memory;
during the execution process of the instructions included in the boot program, execute one of the plurality of interrupt jump s when the instruction execution address of the CPU reaches an address of the boot program writing area where the DMA transfer process has not been completed; and
after the instruction execution address of the CPU is changed to the address of the interrupt program writing area by executing the one of the plurality of interrupt jump instructions, execute the interrupt program written in the interrupt program writing area to delay the execution process of the instructions included in the boot program.

2. The semiconductor device according to claim 1, wherein, after performing a process to delay the execution process of the instructions included in the boot program, the CPU is configured to set the address where the one of the plurality of interrupt jump instructions executed has been written as the instruction execution address again to resume the execution process of the instructions included in the boot program.

3. The semiconductor device according to claim 1, wherein a time to delay the execution process of the instructions included in the boot program is determined according to a difference between a DMA transfer process speed of the boot program and an instruction execution process speed of the boot program.

4. The semiconductor device according to claim 1, wherein the CPU is configured to execute the initialization program to cause the DMA controller to perform DMA transfer processes of the interrupt program and the plurality of interrupt jump instructions to the second memory.

5. The semiconductor device according to claim 1, further comprising the third memory.

6. The semiconductor device according to claim 1,
wherein the boot program includes a first part and a second part,
wherein the DMA controller is a first DMA controller,
wherein the DMA transfer process is a first DMA transfer process,
wherein the boot program writing area includes a first boot program writing area and a second boot program writing area,
wherein the semiconductor device further includes a second DMA controller,
wherein the first DMA controller is configured to start the first DMA transfer process to transfer the first part of the boot program stored in the third memory to the second memory by overwriting the plurality of interrupt jump instructions written in the first boot program writing area,
wherein the second DMA controller is configured to start a second DMA transfer process to transfer the second part of the boot program stored in the third memory to the second memory by overwriting the plurality of interrupt jump instructions written in the second boot program writing area, and
wherein the CPU is configured to:
after a predetermined time has elapsed since a start of the first DMA transfer process and the second DMA transfer process, start an execution process of the instructions included in the boot program DMA-transferred to the second memory; and
during the execution process of the instructions included in the boot program, execute one of the plurality of interrupt jump instructions when the instruction execution address of the CPU reaches an address of the boot program writing area where the first DMA transfer process or the second DMA transfer process has not been completed.

7. The semiconductor device according to claim 6, wherein the CPU is configured to execute the initialization program to cause the first DMA controller and the second DMA controller to perform DMA transfer processes of the interrupt program and the plurality of interrupt jump instructions to the second memory.

8. The semiconductor device according to claim 6, wherein each of the first boot program writing area and the second boot program writing area includes a plurality of areas arranged apart from each other.

9. A boot program execution method executed in a semiconductor device which includes a CPU, a first memory storing an initialization program, a second memory having an interrupt program writing area and a boot program writing area, and a DMA controller, the boot program execution method comprising:
an initialization step to cause the CPU to execute the initialization program;
a boot program transfer step to cause the DMA controller to execute a DMA transfer process of a boot program; and
a boot program execution step to cause the CPU to execute the boot program,
wherein the initialization step includes:
a step of writing an interrupt program including an instruction to delay an execution process of the boot program into the interrupt program writing area; and
a step of writing a plurality of interrupt jump instructions including instructions to change an instruction execution address of the CPU to an address of the interrupt program writing area into the boot program writing area,
wherein the boot program transfer step includes a step of starting the DMA transfer process to transfer the boot program stored in a third memory to the second memory by overwriting the plurality of interrupt jump instructions written in the boot program writing area, and
wherein the boot program execution step includes:
after a predetermined time has elapsed since the start of the DMA transfer process, a step of starting an execution process of instructions included in the boot program DMA-transferred to the second memory;
during the execution process of the instructions included in the boot program, a step of executing one of the plurality of interrupt jump instructions when the instruction execution address of the CPU reaches an address of the boot program writing area where the DMA transfer process has not completed; and
after the instruction execution address of the CPU is changed to the address of the interrupt program writing area by executing the one of the plurality of interrupt jump instructions, a step of delaying the execution process of the instructions included in the boot program by executing the interrupt program written in the interrupt program writing area.

10. The boot program execution method according to claim 9, wherein the boot program execution step further includes, after the step of delaying the execution of the instructions included in the boot program, a step of setting the address where the one of the plurality of interrupt jump instructions executed has been written as the instruction execution address again to resume the execution process of the instructions included in the boot program.

11. The boot program execution method according to claim 9, wherein a time to delay the execution process of the instructions included in the boot program is determined according to a difference between a DMA transfer processing speed of the boot program and an instruction execution process speed of the boot program.

12. The boot program execution method according to claim 9, wherein the initialization step further includes a step of causing the DMA controller to perform DMA transfer processes of the interrupt program and the plurality of interrupt jump instructions to the second memory, by executing the initialization program.

13. The boot program execution method according to claim 9,
wherein the boot program writing area includes a first boot program writing area and a second boot program writing area,
wherein the boot program includes a first part and a second part,
wherein the DMA controller is a first DMA controller,
wherein the DMA transfer process is a first DMA transfer process,
wherein the semiconductor device further includes a second DMA controller,
wherein the boot program transfer step comprises a first boot program transfer step to cause the first DMA controller to perform the first DMA transfer process of the first part of the boot program,
wherein the first boot program transfer step includes a step of starting the first DMA transfer process to transfer the first part of the boot program stored in the third memory to the second memory by overwriting the plurality of interrupt jump instructions written in the first boot program writing area,
wherein the boot program execution method further comprises a second boot program transfer step to cause the second DMA controller to perform a second DMA transfer process of the second part of the boot program,
wherein the second boot program transfer step includes a step of starting the second DMA transfer process to transfer the second part of the boot program stored in the third memory to the second memory by overwriting the plurality of interrupt jump instructions written in the second boot program writing area, and
wherein the boot program execution step further comprises:
after a predetermined time has elapsed since a start of the first DMA transfer process and the second DMA transfer process, a step of starting an execution process of the instructions included in the boot program DMA-transferred to the second memory; and
during the execution process of the instructions included in the boot program, a step of executing one of the plurality of interrupt jump instructions when the instruction execution address of the CPU reaches an address of the boot program writing area where the first DMA transfer process or the second DMA transfer process has not been completed.

14. The boot program execution method according to claim 13, wherein the initialization step further includes a step of causing the first DMA controller and the second DMA controller to perform the step of writing the interrupt program and the step of writing the plurality of interrupt jump instructions, by executing the initialization program.

15. A non-transitory computer readable medium storing a program for causing a semiconductor device to perform a boot program execution method, the semiconductor device including a CPU, a first memory storing an initialization program, a second memory having an interrupt program writing area and a boot program writing area, and a DMA controller, the boot program execution method comprising:
an initialization step to cause the CPU to execute the initialization program;
a boot program transfer step to cause the DMA controller to execute a DMA transfer process of a boot program; and
a boot program execution step to cause the CPU to execute the boot program,
wherein the initialization step includes:
a step of writing an interrupt program including an instruction to delay an execution process of the boot program into the interrupt program writing area; and
a step of writing a plurality of interrupt jump instructions including instructions to change an instruction execution address of the CPU to an address of the interrupt program writing area into the boot program writing area,
wherein the boot program transfer step includes a step of starting the DMA transfer process to transfer the boot program stored in a third memory to the second memory by overwriting the plurality of interrupt jump instructions written in the boot program writing area, and
wherein the boot program execution step includes:
after a predetermined time has elapsed since the start of the DMA transfer process, a step of starting an execution process of instructions included in the boot program DMA-transferred to the second memory;
during the execution process of the instructions included in the boot program, a step of executing one of the plurality of interrupt jump instructions when the instruction execution address of the CPU reaches an address of the boot program writing area where the DMA transfer process has not completed; and
after the instruction execution address of the CPU is changed to the address of the interrupt program writing area by executing the one of the plurality of interrupt jump instructions, a step of delaying the execution process of the instructions included in the boot program by executing the interrupt program written in the interrupt program writing area.

16. The non-transitory computer readable medium according to claim 15, wherein the boot program execution step further includes, after the step of delaying the execution of the instructions included in the boot program, a step of setting the address where the one of the plurality of interrupt jump instructions executed has been written as the instruction execution address again to resume the execution process of the instructions included in the boot program.

17. The non-transitory computer readable medium according to claim 15, wherein a time to delay the execution process of the instructions included in the boot program is determined according to a difference between a DMA transfer processing speed of the boot program and an instruction execution process speed of the boot program.

18. The non-transitory computer readable medium according to claim 15, wherein the initialization step further includes a step of causing the DMA controller to perform DMA transfer processes of the interrupt program and the plurality of interrupt jump instructions to the second memory, by executing the initialization program.

19. The non-transitory computer readable medium according to claim 15,
wherein the boot program writing area includes a first boot program writing area and a second boot program writing area,
wherein the boot program includes a first part and a second part,
wherein the DMA controller is a first DMA controller,
wherein the DMA transfer process is a first DMA transfer process,
wherein the semiconductor device further includes a second DMA controller,
wherein the boot program transfer step comprises a first boot program transfer step to cause the first DMA controller to perform the first DMA transfer process of the first part of the boot program,
wherein the first boot program transfer step includes a step of starting the first DMA transfer process to transfer the first part of the boot program stored in the third memory to the second memory by overwriting the plurality of interrupt jump instructions written in the first boot program writing area,
wherein the boot program execution method further comprises a second boot program transfer step to cause the second DMA controller to perform a second DMA transfer process of the second part of the boot program,
wherein the second boot program transfer step includes a step of starting the second DMA transfer process to transfer the second part of the boot program stored in the third memory to the second memory by overwriting the plurality of interrupt jump instructions written in the second boot program writing area, and
wherein the boot program execution step further comprises:
after a predetermined time has elapsed since a start of the first DMA transfer process and the second DMA transfer process, a step of starting an execution process of the instructions included in the boot program DMA-transferred to the second memory; and
during the execution process of the instructions included in the boot program, a step of executing one of the plurality of interrupt jump instructions when the instruction execution address of the CPU reaches an address of the boot program writing area where the first DMA transfer process or the second DMA transfer process has not been completed.

20. The non-transitory computer readable medium according to claim 19, wherein the initialization step further includes a step of causing the first DMA controller and the second DMA controller to perform the step of writing the interrupt program and the step writing the plurality of interrupt jump instructions, by executing the initialization program.
